(19) United States
(12) Patent Application Publication
(10) Pub. No.: US 2013/0249858 A1
(43) Pub. Date: Sep. 26, 2013

(54) MUTUAL CAPACITIVE TOUCH PANEL AND TOUCH CONTROL SYSTEM

(71) Applicant: MSTAR SEMICONDUCTOR, INC., Hsinchu County (TW)

(72) Inventor: Fu-Sheng Chang, Nantou County (TW)

(73) Assignee: MSTAR SEMICONDUCTOR, INC., Hsinchu County (TW)

(21) Appl. No.: 13/803,751

(22) Filed: Mar. 14, 2013

(30) Foreign Application Priority Data
Mar. 20, 2012 (TW) 101109544

(51) Int. Cl. G06F 3/044

(52) U.S. Cl. CPC G06F 3/044
USPC 345/174

(57) ABSTRACT

A mutual capacitive touch panel includes electrodes arranged in N rows and multiple control channels. The electrodes arranged in N rows are formed on a same plane and are unconnected to one another. Each row of electrodes includes multiple unconnected electrodes. The control channels are formed on the same plane with the electrodes arranged in N rows. Each electrode corresponds to one control channel. A controller cooperating with the mutual capacitive touch panel sends driving signals and receives sensing results via the control channels.

This application claims the benefit of Taiwan application Serial No. 101109544, filed Mar. 20, 2012, the subject matter of which is incorporated herein by reference.

### BACKGROUND OF THE INVENTION

1. Field of the Invention

The invention relates in general to a touch control system, and more particularly, to a technique implementing touch control via single-layer electrodes.

2. Description of the Related Art

Operating interfaces of recent electronic products are getting more and more user-friendly and intuitive as the technology rapidly advances. For example, through a touch screen, a user can directly operate programs as well as input messages/texts/patterns with fingers or a stylus, thus eliminating complexities of input devices such as a keyboard or buttons. In practice, a touch screen usually comprises a touch sensing panel and a display disposed at the back of the touch sensing panel. According to the position of a touch point on the touch sensing panel and the currently displayed image on the display, an electronic device can determine the intention of the touch and carry out corresponding operations.

Current touch sensing techniques can be categorized into five different types: resistive, capacitive, electromagnetic, ultrasonic and optic types. FIG. 1 shows a mutual capacitive touch panel according to a prior art. A plurality of transparent sensing lines, arranged in a matrix, is disposed at the back of a touch sensing panel. In this example, the sensing wires in an X direction are driving lines whereas the sensing wires in a Y direction are sensing lines. Each of the driving sensing wires is connected to a driver 12, and each of the receiving sensing wires is connected to a receiver 14. In general, the drivers 12 send out driving signals sequentially, and the receivers 14 receive sensing signals continuously. When a valid touch takes place, capacitance coupling occurs between the driving sensing wire and the receiving sensing wire corresponding to the touch point, resulting in a change of a sensing signal (e.g., a voltage value) associated with a mutual capacitance. According to the position of the receiver 14 which detects the change of the sensing signal and the position of the driver 12 which sends out the driving signal at the time of the touch, a circuit can subsequently determine the coordinate of the touch point in both the X and Y directions.

Driving wires and sensing wires are transparent electrodes disposed on two different planes conventionally. A dielectric layer is provided to form mutual capacitances between the driving wires and the sensing wires in the two planes. FIG. 2A shows a diagram of a prevalent rhombus electrode pattern according to a prior art. Dark-shaded rhombus electrodes 16 with the same Y coordinate are connected to one another to form driving sensing wires in the X direction; light-shaded rhombus electrodes 18 with the same X coordinate are connected to one another to form driving sensing wires in the Y direction. It should be noted that the dark-shaded rhombus electrodes 16 and the light-shaded rhombus electrodes 18 are located on two different planes and the overlapping parts of the two types of electrodes as appeared in the diagram are physically unconnected.

To reduce the cost of material, many manufacturers compress the aforementioned double-layer electrode structure to a single-layer electrode structure. In a conventional single-layer electrode structure, main rhombus bodies of the dark-shaded rhombus electrodes 16 and the light-shaded rhombus electrodes 18 are formed on the same plane. FIG. 2B is a top view of a single-layer electrode structure according to a prior art. The overlapping part of two types of electrodes is implemented by a three-dimensional bridge structure. In this single-layer electrode structure, a connecting line between two dark-shaded rhombus electrodes 16 is located on the same plane as the rhombus electrodes; a connecting line between two light-shaded rhombus electrodes 18 is elevated to be above the plane—as indicated by a light connecting line crossing over a dark connecting line in the diagram. It can be observed from the diagram that the single-layer electrode structure is not really a single-layer structure. Due to complex manufacturing procedure of the above three-dimensional bridge structure, the implementation of the conventional single-layer electrode structure is still costly and complicated.

### SUMMARY OF THE INVENTION

The invention directs towards a mutual capacitive touch panel and a corresponding mutual capacitive touch control device, which applies electrodes and control channels formed on a same plane for implementing touch control without requiring a conventional three-dimensional bridge structure, thus reducing manufacturing complications and production costs of a touch control device.

According to one embodiment of the instant invention, a mutual capacitive touch panel is provided. The mutual capacitive touch panel comprises electrodes arranged in N rows and a plurality of control channels.

The electrodes are formed on a same plane and are unconnected to one another. Each row of electrodes comprises a plurality of unconnected electrodes. The control channels are formed on the same plane with the electrodes. Each electrode corresponds to one control channel. A controller cooperating with the mutual capacitive touch panel sends a plurality of driving signals and receives a plurality of sensing results via the control channels. A target electrode in the electrodes can receive a driving signal at a first time point, and provide one of the sensing results at a second time point.

According to another embodiment of the instant invention, a mutual capacitive touch control device is provided. The mutual capacitive touch control device comprises electrodes arranged in N rows, a plurality of control channels and a controller. The electrodes are formed on a same plane and are unconnected to one another. Each row of electrodes comprises a plurality of unconnected electrodes. The control channels are formed on the same plane with the electrodes. Each electrode corresponds to one control channel. The controller sends a plurality of driving signals and receives a plurality of sensing results via the control channels. Further, the controller can send a driving signal to a target electrode in the electrodes at a first time point, and receive one of the sensing results from the target electrode at a second time point.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an example of a mutual capacitive touch panel.

FIG. 2A is a schematic diagram of a rhombus electrode pattern.

FIG. 2B is a schematic diagram of a three-dimensional bridge structure in a conventional single-layer electrode structure.

FIG. 3A is a block diagram of a touch control device according to one embodiment of the instant invention.

FIG. 3B is a diagram showing mutual capacitance between electrodes.

FIG. 3C is a diagram showing sensing areas corresponding to mutual capacitances.

FIG. 4A is a schematic diagram of a bow-shaped electrode pattern according to one embodiment of the instant invention.

FIG. 4B and FIG. 4C are enlarged partial views of FIG. 4A.

FIG. 5A and FIG. 5B are tables of experimental data according to the instant invention.

FIG. 6 is a schematic diagram showing an example of a wiring arrangement of control channels in a bow-shaped electrode pattern according to one embodiment of the instant invention.

FIG. 7A is a schematic diagram showing an example of an electrode pattern according to one embodiment of the instant invention.

FIG. 7B is a schematic diagram showing an electrode in an example of an electrode pattern according to one embodiment of the instant invention.

FIG. 7C is a schematic diagram showing an example of an electrode pattern referring to FIG. 7B.

### DETAILED DESCRIPTION OF THE INVENTION

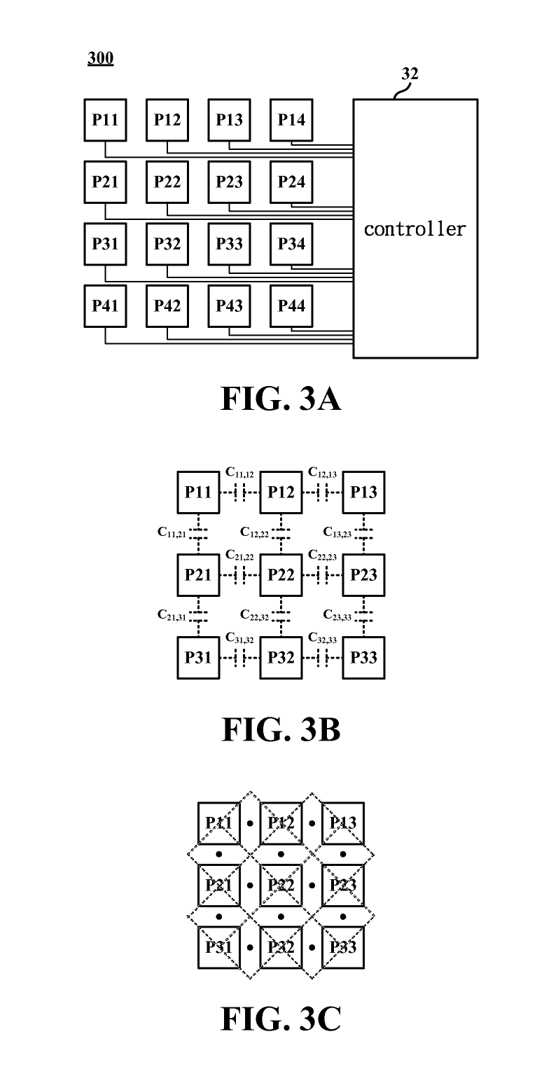

FIG. 3A shows a mutual capacitive touch control device 300 according to one embodiment of the instant invention. For example, the touch control device 300 may be integrated into an electronic system such as a mobile communication equipment, a tablet computer, a personal computer or an interactive information display billboard. The touch control device 300 comprises 16 rectangular electrodes P11 to P44 arranged in a matrix and a controller 32. As shown in FIG. 3A, the electrodes P11 to P44, formed on a same plane, are unconnected to one another and are connected to the controller 32 via independent control channels respectively. Wires forming the control channels are also disposed on the same plane as the electrodes P11 to P44, and can be arranged more densely to reduce gaps between neighboring electrodes.

FIG. 3B shows a schematic diagram of capacitors among the electrodes P11 to P33. Mutual capacitance is induced between every two neighboring electrodes. According to changes in the mutual capacitance, the controller 32 can determine the position of a touch point. For example, for a touch point occurring at a center of the electrode P22, capacitance changes at capacitors C_{12, 22}, C_{21, 22}, C_{22, 23} and C_{22, 32} are most prominent; for a touch point occurring between the electrodes P12 and P22, capacitance change at the capacitor C_{12, 22} is more noticeable than those at other capacitors. On the other hand, when the capacitance changes at the capacitors C_{21, 22}, C_{21, 31}, C_{31, 32} and C_{22, 32} are more prominent than those at other capacitors, it can be determined that a touch point occurs at the proximity of an intersection of the electrodes P21, P22, P31 and P32. Referring to FIG. 3C, coordinates of mutual capacitance sensing points corresponding to the mutual capacitances are indicated in solid dots, and effective sensing areas corresponding to the mutual capacitance sensing points are demarcated by dotted lines.

In this embodiment, the electrodes may be alternatively set as driving components for receiving driving signals at different time points, or as receiving components for providing sensing results, respectively. In other words, different from the prior art, the electrodes in this embodiment are not fixed as a driving component or a sensing component. For example, at a particular time point, the controller 32 may first send a driving signal to the electrode P22, and respectively measure the voltage of the eight electrodes (P11, P12, P13, P21, P23, P31, P32 and P33) adjacent to or encompassing the electrode P22 to determine whether a touch point occurs near the electrode P22. At a next time point, the controller 32 may utilize the electrode P23 as a driving component, and implement the eight electrodes (P12, P13, P14, P22, P24, P32, P33 and P34) encompassing the electrode P23 as sensing components to determine whether a touch point occurs near the electrode P23.

Similarly, the electrodes P11 to P44 in FIG. 3A may be set as driving components for receiving the driving signal in a specific or randomized order. For example, the controller 32 may periodically utilize the electrodes P11 to P44 in sequence as a driving target, and performs scanning from left to right and from top to bottom. As long as the scanning speed is fast enough, a user touch may not be missed. Such scanning method has an advantage in being capable to prevent misjudgment caused by a ghost point. It should be noted that, the number of corresponding sensing components is not limited to eight, as in the above embodiment, when a target electrode is selected as a driving component. For example, when the electrode P22 is selected as a driving component, the controller 32 may select merely four electrodes (P12, P21, P23 and P32) as sensing components, or may select more than eight electrodes as sensing components.

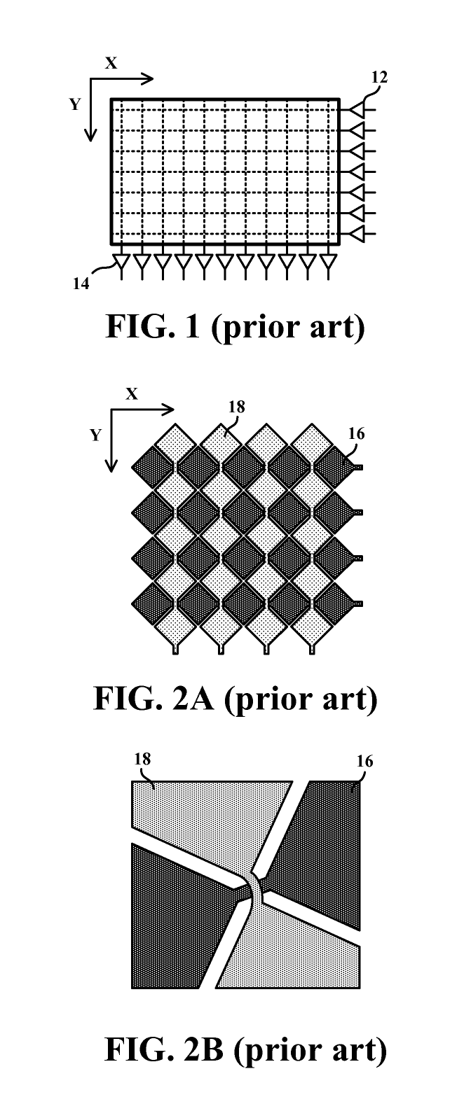

In practice, the controller 32 may comprise only one driver (similar to the driver 12 in FIG. 1), but connect the driver to different electrodes at different time points through the switching of a multiplexer. Similarly, the controller 32 may comprise eight (or other fixed numbers) receivers (similar to the receiver 14 in FIG. 1), and control the electrodes serving as sensing components to send sensing results to the receiver through the switching of a multiplexer.

As shown in FIG. 3A, each of the electrodes P11 to P44 connects to the controller 32 via an independent control channel. Wires of the control channels do not overlap with one another, thus the conventional three-dimensional bridge structure is not required. In practice, the number, shape and arrangement of the electrodes are not limited to those depicted in FIG. 3A. The above approach may be applied to various types of mutual capacitive control panels comprising electrodes arranged in N rows formed on the same plane (where N is an integer greater than 1). The electrodes are unconnected, and each row comprises a plurality of unconnected electrodes.

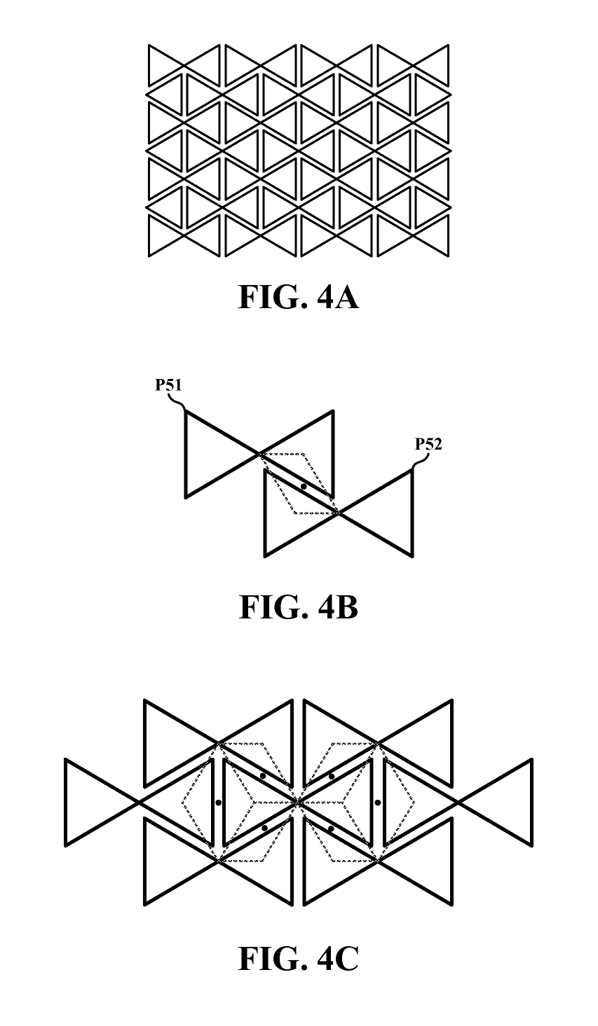

In an alternative embodiment as shown in FIG. 4A, each of the electrodes has a profile of a bow shape, formed by two solid triangles connected by vertices. Each of the electrodes are also connected to the controller 32 via an independent control channel (not shown), respectively.

FIG. 4B and FIG. 4C are enlarged partial views of FIG. 4A. Referring to FIG. 4B showing two neighboring electrodes P51 and P52, the solid dot in the gap represents the position coordinate of the mutual capacitance sensing point between the electrodes P51 and P52, and the quadrilateral indicated in dotted lines corresponds to the sensing area of the solid dot. FIG. 4C shows three rows of electrodes, which comprise two, three and two electrodes from top to bottom respectively. Taking the middle electrode of the second row as an example, six edges of the bow shape are respectively neighboring to six different electrodes and located in six different sensing areas (demarcated in dotted lines) including six different sensing points as depicted. The sensing areas may be designed as same-sized. The controller 32 detects the mutual capacitance changes between the electrodes, and calculates the coordinate of a touch point according to the position coordinates of mutual capacitance sensing points where the mutual capacitance changes are greater than a predetermined value (e.g., by a center of gravity equation).

It is proven through experiments that, compared to the rectangular electrode pattern in FIG. 3A, the bow-shaped electrode pattern shown in FIG.

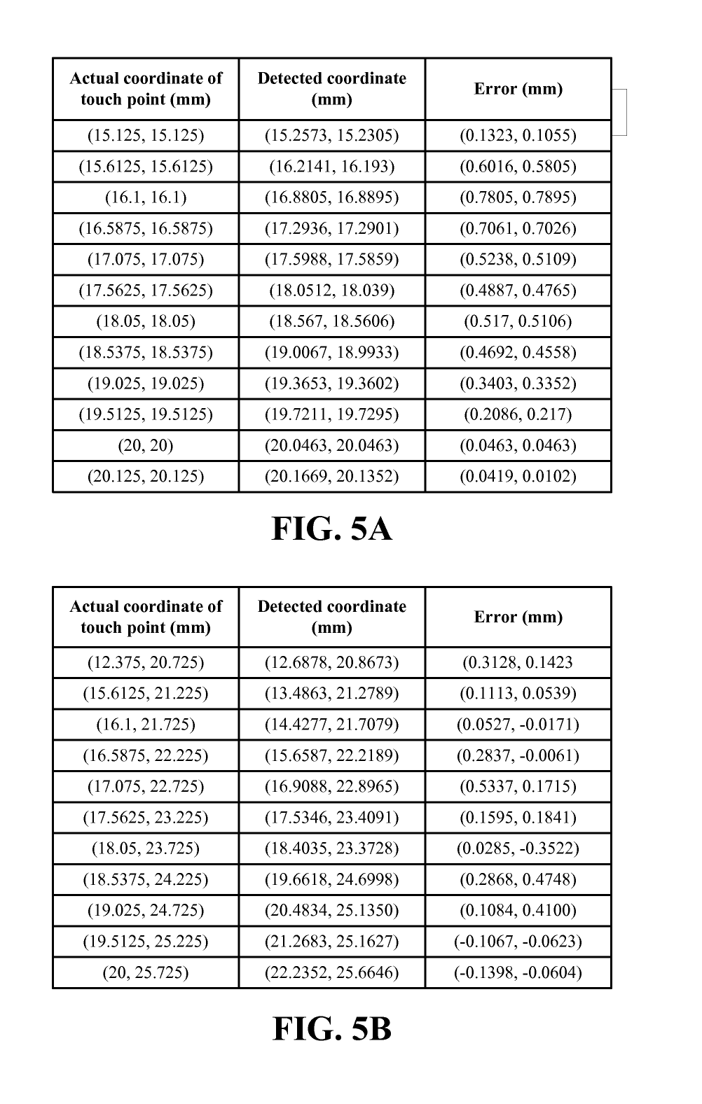

4A renders detection results with a preferred linearity. The experimental data generated by the two types of electrode patterns are presented in FIG. 5A and FIG. 5B, respectively. In the experiment, it is assumed that the sizes of the sensing areas of the mutual sensing points are the same, and the sensing areas are given same weightings in the calculation according to a center of gravity equation. The left column represents actual coordinates of touch points simulated by software, the middle column represents coordinates determined according to mutual capacitance changes and a center of gravity equation, and the right column represents differences between two coordinates in the left and middle columns. It is seen from the tables that, a maximum error of the rectangular electrode pattern is 0.78 mm, whereas a maximum error of the bow-shaped electrode pattern is 0.5 mm.

Again referring to FIG. 3C, each of the rectangular electrodes is principally adjacent to four other electrodes to form four mutual capacitances therebetween. The four mutual capacitances can be simplified and denoted as four mutual capacitance sensing points in FIG. 3C, and each of the rectangular electrodes respectively contribute one-half of the mutual capacitance change of the mutual capacitance sensing points in each sensing area. Thus, each rectangular electrode substantially covers 4½=2 sensing areas. In contrast, referring to FIG. 4C showing the bow-shaped electrode pattern, each of the bow-shaped electrodes is principally adjacent to six other electrodes to form six mutual capacitances. The six mutual capacitances can be simplified and demoted as six mutual capacitance sensing points, and each of the bow-shaped electrodes respectively contribute one-half of the mutual capacitance change of the mutual capacitance sensing points in each sensing area. Thus, each bow-shaped electrode substantially covers 6½=3 sensing areas. Therefore, it can be deduced that, assuming two same-sized mutual capacitance touch panels are respectively formed by the rectangular electrode pattern in FIG. 3C and the bow-shaped electrode pattern in FIG. 4C, and the area of each rectangular electrode equals that of each bow-shaped electrode, it is apparent that the numbers of the sensing areas and the mutual capacitance sensing points of the mutual capacitive touch panel formed by the bow-shaped electrode pattern are 1.5 times of those of the mutual capacitive touch panel formed by the rectangular electrode pattern. In other words, the bow-shaped electrode pattern in FIG. 4C significantly increases densities of the sensing areas and the mutual capacitance sensing points for positioning a touch point, so that positioning capability of the touch control device is effectively improved.

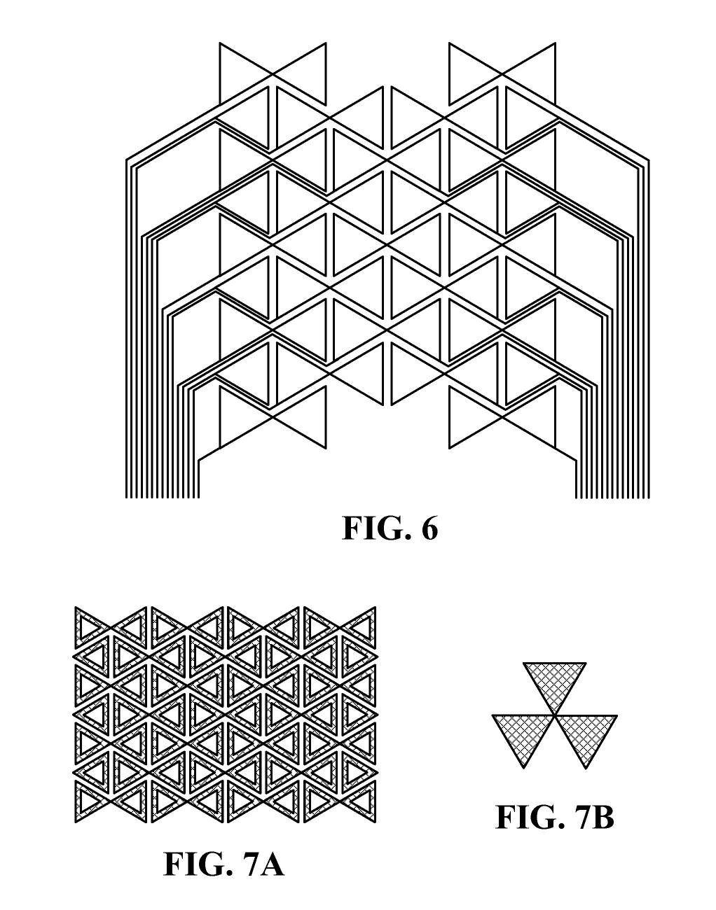

FIG. 6 shows an example of a wiring arrangement of control channels applicable to the bow-shaped electrode pattern in FIG. 4A. As shown in FIG. 6, each of the electrodes corresponds to an independent control channel and the wires of the control channels do not overlap with one another, thus the conventional three-dimensional bridge structure is not required.

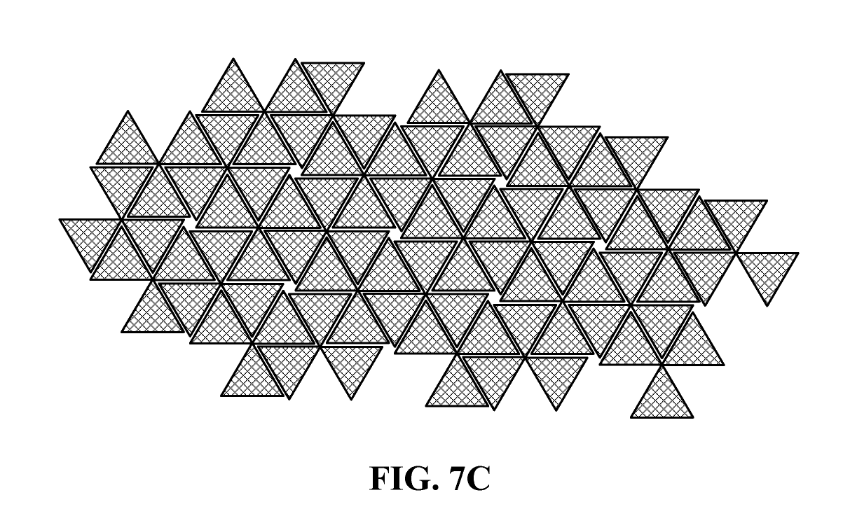

Referring to FIG. 7A showing another embodiment of the instant invention, each of the electrodes appears as a bow shape formed by two hollow triangles connected by vertices, with the shaded parts representing a solid material forming the electrodes and the un-shaded parts representing areas with no materials. Such approach of eliminating part of an electrode can reduce the amount of the material required for forming electrodes.

Referring to FIG. 7B showing yet another embodiment, each of the electrodes appears as a combined shape formed by three triangles connected by vertices to further form an electrode pattern shown in FIG. 7C. In practice, the triangles of the electrodes may be equilateral triangles or any triangles. The controller 32 similarly controls the electrode patterns according to the methods previously described referring to FIGS. 4A, 7A and 7B.

According to another embodiment of the instant invention, a mutual capacitive touch panel is provided. The mutual capacitive touch panel in this embodiment comprises electrodes arranged in N rows and control channels but not the controller 32. The electrodes are formed on a same plane and are unconnected with one another. Each row of electrodes comprises a plurality of unconnected electrodes (e.g., electrodes as shown in FIGS. 3A, 4A, 7A or 7B). The control channels are formed on the same plane as the electrodes. Each electrode corresponds to a control channel. A controller cooperating with the mutual capacitive touch panel sends driving signals and receives sensing results via the control channels.

Therefore, a mutual capacitive touch panel and a corresponding mutual capacitive touch control device are provided by the embodiments of the instant invention. In the mutual capacitive touch panel and the corresponding mutual capacitive touch control device, the electrodes are formed on the same plane as the control channels, so that the conventional three-dimensional bridge structure is not required and manufacturing complications and costs of the touch control device are reduced accordingly.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mutual capacitive touch panel, for jointly operating with a controller, comprising:
a first row of electrodes and a second row of electrodes, formed on a same plane and unconnected with one another, wherein each electrode in said first row is not connected with one another and each electrode in said second row is not connected with one another and
a plurality of control channels, formed on said same plane as said first row and said second row of electrodes, wherein each electrode in said first row and said second row corresponding to one said control channel;
wherein, said controller sends a plurality of driving signals to said first row and said second row of electrodes or receives a plurality of sensing results from said first row and said second row of electrodes via said control channels, and a target electrode in said first row and said second row of electrodes receives one of said driving signals at a first time point, and provides one of said sensing results at a second time point.

2. The mutual capacitive touch panel according to claim 1, wherein each electrode in said first row and said second row is a rectangle.

3. The mutual capacitive touch panel according to claim 1, wherein each electrode in said first row and said second row has a profile of a bow shape formed by two solid triangles connected via vertices.

4. The mutual capacitive touch panel according to claim 1, wherein each electrode in said first row and said second row has a profile of a bow shape formed by two hollow triangles connected via vertices.

5. The mutual capacitive touch panel according to claim 1, wherein each electrode in said first row and said second row has a profile combined by three triangles connected via vertices.

6. The mutual capacitive touch panel according to claim 1, wherein electrodes in said first row and said second row adjacent to said target electrode provide said sensing results at said first time point.

7. The mutual capacitive touch control panel according to claim 6, wherein different electrodes in said first row and said second row being selected by said controller sequentially as said target electrode.

8. A mutual capacitive touch control device, comprising:
a first row of electrodes and a second row of electrodes, formed on a same plane and unconnected with one another, wherein each electrode in said first row is not connected with one another and each electrode in said second row is not connected with one another and a plurality of control channels, formed on said same plane as said first row and said second row of electrodes, wherein each electrode in said first row and said second row corresponding to one said control channel;
a controller, for sending a plurality of driving signals to electrodes in said first row and said second row of electrodes or receiving a plurality of sensing results from electrodes in said first row and said second row of electrodes via said control channels;
wherein, said controller sends one of said driving signals to a target electrode in said first row and said second row of electrodes at a first time point, and receives one of said sensing results from said target electrode at a second time point.

9. The mutual capacitive touch control device according to claim 8, wherein each electrode in said first row and said second row is a rectangle.

10. The mutual capacitive touch control device according to claim 8, wherein each electrode in said first row and said second row is a bow shape formed by two solid triangles connected via vertices.

11. The mutual capacitive touch control device according to claim 8, wherein each electrode in said first row and said second row is a bow shape formed by two hollow triangles connected via vertices.

12. The mutual capacitive touch control device according to claim 8, wherein each electrode in said first row and said second row is a combined shape formed by three triangles connected via vertices.

13. The mutual capacitive touch control device according to claim 8, wherein said controller selects electrodes in said first row and said second row of electrodes that are adjacent to said target electrode for receiving said sensing results at said first time point.

14. The mutual capacitive touch control device according to claim 13, wherein said controller sequentially selects different electrodes in said first row and said second row of electrodes as said target electrode.
